(19) United States
(12) Patent Application Publication
(10) Pub. No.: US 2007/0064317 A1
(43) Pub. Date: Mar. 22, 2007

(54) Image sensor package structure

(76) Inventors: Po-Hung Chen, Shin-Chu (TW); Mao-Jung Chen, Shin-Chu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/231,848

(22) Filed: Sep. 22, 2005

(51) Int. Cl. G02B 7/02

(52) U.S. Cl. 359/811

(57) ABSTRACT

An image sensor package structure is proposed, in which the electric connection of an image sensing chip and the assembly of a housing and a lens barrel are separately carried out to avoid restriction in the packaging process and influence of outside contaminants. Moreover, corresponding faces of the housing and the lens barrel are designed to be smooth surfaces to reduce the probability of adhesion and accumulation of outside contaminants, thereby enhancing the process yield and also reducing the process cost.

### BACKGROUND OF THE INVENTION

1. Field of the Invention

The present invention relates to an image sensor package structure and, more particularly, to an image sensor package structure capable of enhancing the production yield.

2. Description of Related Art

As shown in FIG. 1 in a conventional image sensor package structure, flange layer 11 and a cavity 12 are formed on an injection molded housing 10. An image sensing chip 13 is then placed in the cavity 12. The flange layer is of an inner transparent layer 14 is placed on the cavity 12. The flange layer is of an inner thread type to match a lens barrel 15 with an outer thread. The lens barrel 15 includes a through hole 16, an aspheric lens 17, and an IR-cut filtering lens 18. Besides, a sealant 19 is used in the cavity 12 and covers the image sensing chip 13.

In the above conventional package structure, the surface mount technology (SMT) is utilized to achieve electric connections of a printed circuit board during the production process. Generally speaking, the SMT process is performed in environments with temperature above 200° C. to make electric connections. Because most today's lenses are plastic lenses that cannot tolerate such high temperatures, if the lens barrel 15 is installed on the housing 10 before performing the SMT process, the plastic lens may deform in the high temperature environment to cause problems in optical imaging.

Therefore, it is necessary to install the lens barrel 15 after the SMT process. The SMT process, however, is not performed in a clean room. That is, the prior art needs to make use of the cleaning process to remove particle contaminants produced in the SMT process. It is very difficult to clean particle contaminants of the housing 15 having the flange layer 11 with an inner thread. The process yield and quality are thus badly affected.

### SUMMARY OF THE INVENTION

An object of the present invention is to provide an image sensor package structure, in which the housing and the lens barrel are assembled in a non-thread way, and particle contaminants produced in the SMT process can be avoided, thereby enhancing the process yield and generally solving the problems in the prior art.

Another object of the present invention is to provide an image sensor package structure manufactured in a two-state packaging way so as to avoid various restrictions occurring in the conventional production process.

To achieve the above objects, an image sensor package structure of the present invention comprises a substrate, a shaped body, an image sensing chip, a housing, and a lens barrel. A plurality of metallization traces is disposed on the surface of the substrate. The shaped body is installed on the substrate and forms a cavity. The image sensing chip is installed in the cavity and electrically connected to the substrate via the metallization traces. A lens and a through hole are disposed at the central line of the lens barrel. The lens can receive light from a light source via the through hole. The housing is a hollow body with two open ends, and can be installed above or enclose the shaped body. The lens barrel is movably sleeved in the housing. The housing is used to protect and guide or assist in guiding the lens barrel to make relative motion with respect to the image sensing chip for optical imaging. The inner surface of the housing and the outer surface of the lens barrel are corresponding smooth surfaces to avoid adhesion and accumulation of outside contaminants during the manufacturing process. Because the assembly of the lens barrel and the housing and the electric connections of the image sensing chip can be separately performed, the production process is easier, and the probability that the image sensing chip is contaminated by outside contaminants can be reduced.

The present invention also provides another image sensor package structure, which comprises a shaped body, an image sensing chip, a housing, and a lens barrel. A plurality of metallization traces are directly disposed on the surface of the shaped body. The shaped body has a cavity to receive the image sensing chip. The image sensing ship is electrically connected to the shaped body via the metallization traces. A lens and a through hole are disposed at the central line of the lens barrel. The lens can receive light from a light source via the through hole. The housing is a hollow body with two open ends, and can be installed above or enclose the shaped body. The lens barrel is movably sleeved in the housing. The housing is used to protect and guide or assist in guiding the lens barrel to make relative motion with respect to the image sensing chip for optical imaging. The inner surface of the housing and the outer surface of the lens barrel are corresponding smooth surfaces to avoid adhesion and accumulation of outside contaminants during the manufacturing process. Because the assembly of the lens barrel and the housing and the electric connections of the image sensing chip can be separately performed, the production process is easier, and the probability that the image sensing chip is contaminated by outside contaminants can be reduced.

### BRIEF DESCRIPTION OF THE DRAWINGS

The various objects and advantages of the present invention will be more readily understood from the following detailed description when read in conjunction with the appended drawings, in which:

FIG. 1 is a diagram of a conventional image sensor package structure;

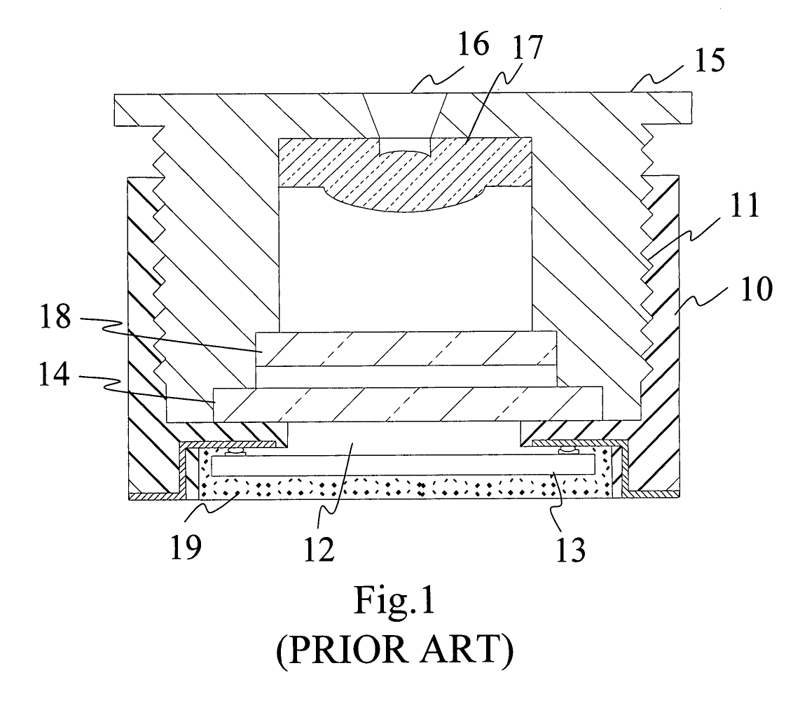

FIG. 2 is a diagram of an image sensor package structure according to a first embodiment of the present invention:

FIG. 3 is a diagram of an image sensor package structure according to a second embodiment of the present invention:

FIG. 4 is a diagram of an image sensor package structure according to a third embodiment of the present invention; and

FIG. 5 is a diagram of an image sensor package structure according to a fourth embodiment of the present invention.

### DETAILED DESCRIPTION OF THE PREFERRED EMBODIMENTS

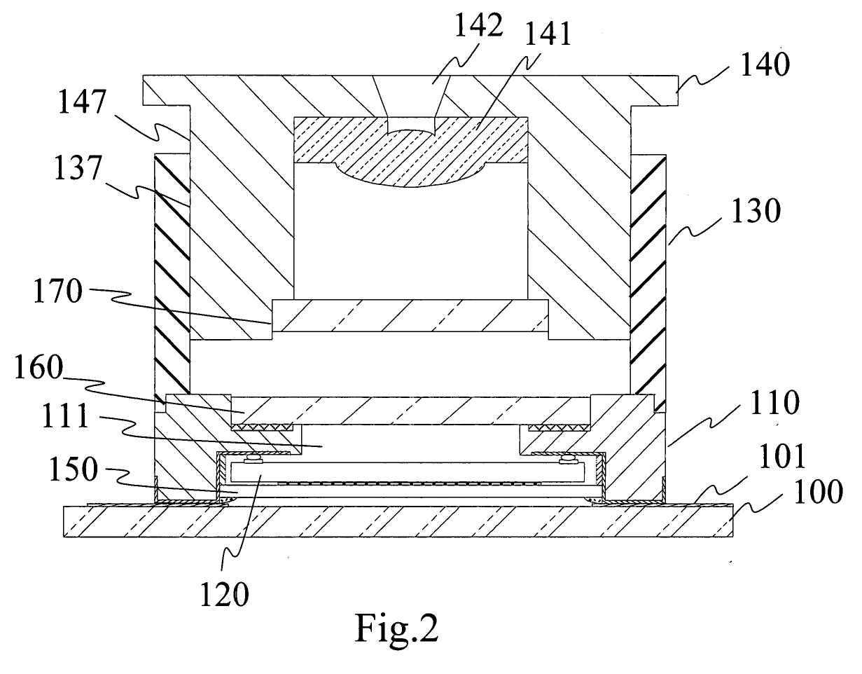

As shown in FIG. 2, the present invention provides an image sensor package structure, which comprises a substrate 100, a shaped body 110, an image sensing chip 120, a housing 130, and a lens barrel 140. A plurality of metallization traces 101 is disposed on the surface of the substrate 100. The shaped body 110 is installed on the substrate 100 and forms a cavity 111. The image sensing chip 120 is installed in the cavity 111 and electrically connected to the substrate 100 via the metallization traces 101. The lens barrel 140 includes a lens 141 and a through hole 142. The through hole 142 penetrates through the central line of the lens barrel 140, and is unobstructed to a light source so that the lens 141 can receive light from the light source via the through hole 142 to focus and transmit light to the image sensing chip 120. The housing 130 is a hollow body with two open ends, and is installed above the shaped body 110. The lens barrel 140 is movably sleeved in the housing 130. The housing 130 is used to protect and guide or assist in guiding the lens barrel 140 to make relative motion with respect to the image sensing chip 120 for optical imaging. The lens barrel 140 is a cylinder. The inner surface of the housing 130 and the outer surface of the lens barrel 140 are corresponding smooth surfaces to avoid adhesion and accumulation of outside contaminants during the manufacturing process. The so-called smooth surfaces means the edges 137 and 147 are continuous surfaces instead of threaded surfaces with acute bend angles in the cross-section view. Therefore, the probability of adhesion and accumulation of outside contaminants can be reduced. In addition to the cylindrical shape, the lens barrel 140 can also be of any coned shape.

The packaging of the image sensor package structure according to this embodiment of the present invention can be performed in two stages. In the first stage, electric connection between the image sensing chip 120 and the substrate 100 is performed. In the second stage, the housing 130 and the lens barrel 140 are assembled above the image sensing chip 120. The second stage is proceeded only after it is confirmed that there is no outside contaminants in the first stage. The situation of outside particle contamination after the whole packaging process can thus be avoided, hence enhancing the process yield.

The image sensing chip 120 in this embodiment is fabricated by means of flip chip to reduce the required bonding area of bonding wire so as to accomplish a miniaturized package.

In this embodiment, a back cover layer 150 can further be placed in the cavity 111 of the shaped body 110 to cover the image sensing chip 120 so as to prevent outside particles from contaminating the image sensing chip 120. Moreover, A light transparent layer 160 can be provided above the image sensing chip 120. This light transparent layer 160 can be an IR-cut filtering lens. A light filtering layer 170 can also be provided at the bottom end of the lens barrel 140. The light filtering layer 170 can also be an IR-cut filtering lens.

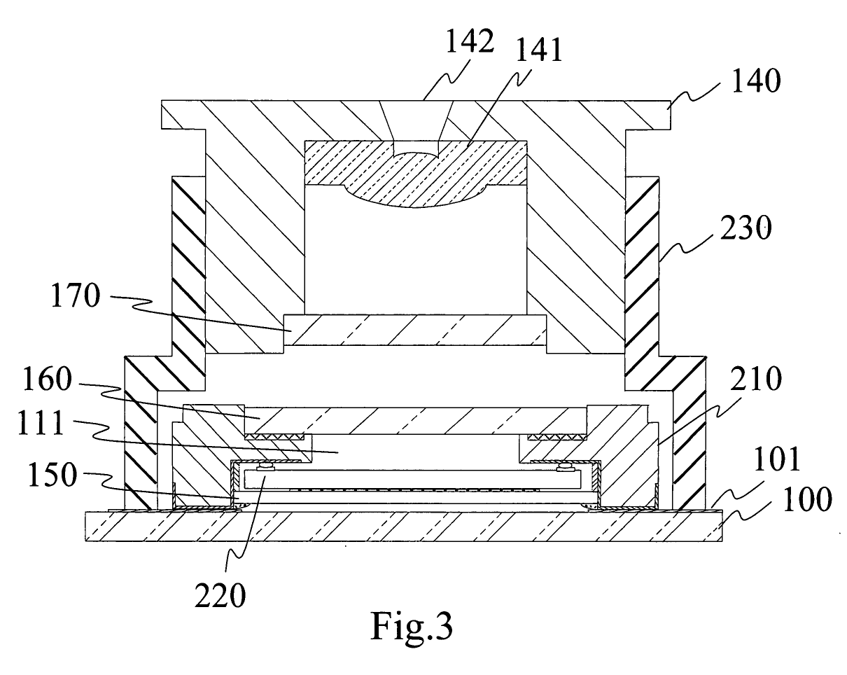

In the above embodiment, the housing 130 is placed above the image sensing chip 120. According to the second embodiment of the present invention, a housing 230 is sleeved around a shaped body 210 to enclose the image sensing chip 220, as shown in FIG. 3.

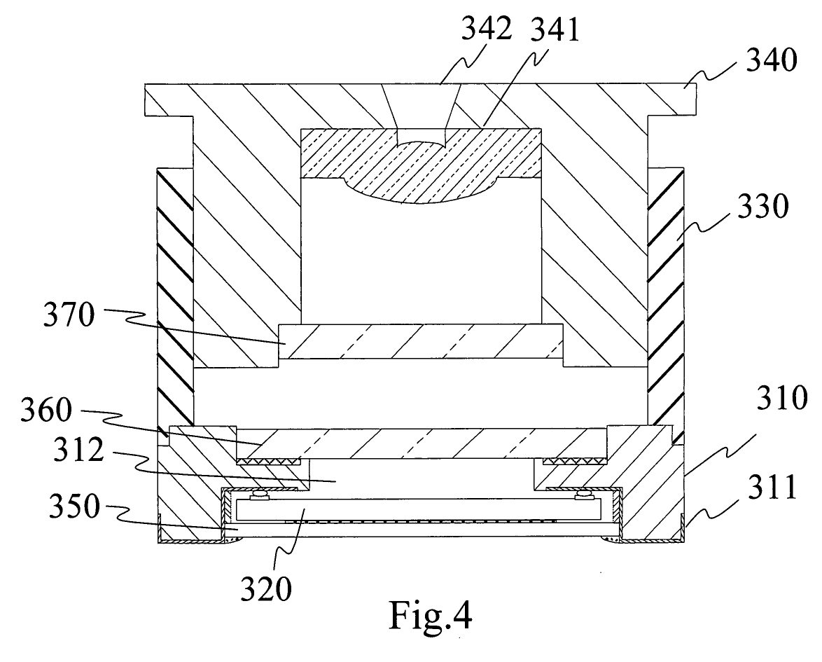

In the above two embodiments, the image sensing chip is electrically connected to the substrate. In practice, the substrate call be excluded. According to the third embodiment of the present invention shown in FIG. 4, an image sensor package structure comprises a shaped body 310. The image sensing chip 320, a housing 330, and a lens barrel 340. A plurality of metallization traces 311 is disposed on the surface of the shaped body 310. The shaped body 310 has a cavity 312. The image sensing chip 320 is installed in the cavity 312 and electrically connected to the shaped body 310 via the metallization traces 311. The lens barrel 340 includes a lens 341 and a through hole 342. The through hole 342 penetrates through the central line of the lens barrel 340, and is unobstructed to a light source so that the lens 341 can receive light from the light source via the through hole 342 to focus and transmit light to the image sensing chip 320. The housing 330 is a hollow body with two open ends, and is installed above the shaped body 310. The lens barrel 340 is movably sleeved in the housing 330. The housing 330 is used to protect and guide or assist in guiding the lens barrel 340 to make relative motion with respect to the image sensing chip 320 for optical imaging. The inner surface of the housing 330 and the outer surface of the lens barrel 340 are corresponding smooth surfaces to avoid adhesion and accumulation of outside contaminants during the manufacturing process.

A back cover 350 can further be placed below the image sensing chip 320 to avoid contamination of the image sensing chip 320. Moreover, A light transparent layer 360 can be provided above the image sensing chip 320. A light filtering layer 370 can also be provided at the bottom end of the lens barrel 340. The light transparent layer 360 and the light filtering layer 370 can be an IR-cut filtering lenses.

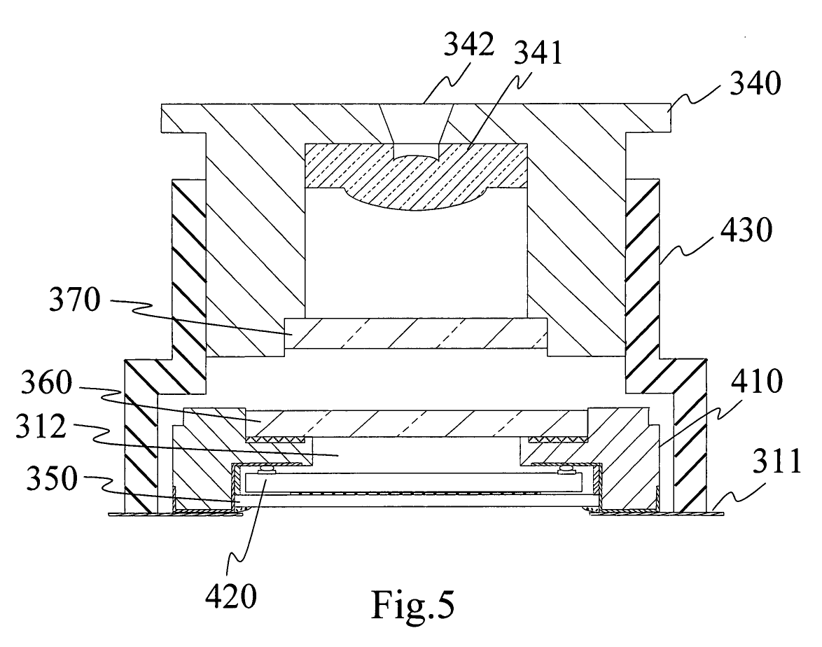

According to the fourth embodiment of the present invention shown in FIG. 5, a housing 430 is sleeved around a shaped body 410 to enclose the image sensing chip 420.

To sum it up, the image sensor package structure of the present invention can be manufactured by means of two-stage packaging to prevent not easy cleaning and unwanted particle sources from affecting the process yield and quality. Moreover, the housing and the lens barrel can be assembled in a non-thread way to further reduce the probability of contamination. Besides, the present invention manufactures an image sensing chip by means of flip chip to enhance the feasibility of miniaturized package.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. An image sensor package structure comprising:
a substrate with a plurality of metallization traces on a surface thereof;
a shaped body installed on said substrate and forming a cavity;
an image sensing chip installed in said cavity and electrically connected to said substrate via said metallization traces,
a housing being a hollow body with two open ends and having a smooth inner surface and installed above said shaped body; and
a lens barrel being a cylinder with a smooth outer surface and movably sleeved in said housing to make relative motion with respect to said image sensing chip, said lens barrel having at least a lens and a through hole, said hole being unobstructed to a light source so that said lens can receive light from said light source.

2. The image sensor package structure of claim 1, further comprising a light transparent layer installed above said image sensing chip.

3. The image sensor package structure of claim 2, wherein said light transparent layer is an IR-cut filtering lens.

4. The image sensor package structure of claim 1, further comprising a light filtering layer, which is disposed at a bottom end of said lens barrel and used to filter said light source.

5. The image sensor package structure of claim 4, wherein said light filtering layer is an IR-cut filtering lens.

6. The image sensor package structure of claim 1, further comprising a back cover layer, which is installed below said image sensing chip to prevent outside contaminants from contaminating said image sensing chip.

7. The image sensor package structure of claim 1, wherein said housing is located above said image sensing chip.

8. The image sensor package structure of claim 1, wherein said housing encloses said shaped body.

9. An image sensor package structure comprising:
a shaped body with a plurality of metallization traces on a surface thereof and forming a cavity;
an image sensing chip installed in said cavity and electrically connected to said shaped body via said metallization traces,
a housing being a hollow body with two open ends and having a smooth inner surface and installed in said shaped body; and
a lens barrel being a cylinder with a smooth outer surface and movably sleeved in said housing to make relative motion with respect to said image sensing chip, said lens barrel having at least a lens and a through hole, said hole being unobstructed to a light source so that said lens can receive light from said light source.

10. The image sensor package structure of claim 9, further comprising a light transparent layer installed above said image sensing chip.

11. The image sensor package structure of claim 10, wherein said light transparent layer is an IR-cut filtering lens.

12. The image sensor package structure of claim 9, further comprising a light filtering layer, which is disposed at a bottom end of said lens barrel and used to filter said light source.

13. The image sensor package structure of claim 12, wherein said light filtering layer is an IR-cut filtering lens.

14. The image sensor package structure of claim 9, further comprising a back cover layer, which is installed below said image sensing chip to prevent outside contaminations from contaminating said image sensing clip.

15. The image sensor package structure of claim 9, wherein said housing is located above said image sensing clip.

16. The image sensor package structure of claim 9, wherein said housing encloses said shaped body.
